(19) United States
(12) Patent Application Publication
(10) Pub. No.: US 2023/0136384 A1
(43) Pub. Date: May 4, 2023

(54) OPERATING CONSOLE

(71) Applicant: Graf-Syteco GmbH & Co. KG, Tuningen (DE)

(72) Inventor: Steffen HAFNER, Spaichingen (DE)

(21) Appl. No.: 17/979,503

(22) Filed: Nov. 2, 2022

(30) Foreign Application Priority Data
Nov. 2, 2021 (DE) 10 2021 128 470.8

(51) Int. Cl. B60K 35/00

(52) U.S. Cl. CPC B60K 35/00; B60K 2370/111; B60K 2370/115; B60K 2370/1438; B60K 2370/188; B60K 2370/20

(57) ABSTRACT

An operating console for operating a device includes a display configured as a resistive touch display having a touch surface. A film covers the touch surface and has a function key including a transparent or at least translucent see-through region in an environment, and through which the display is visually perceptible, and includes an arching region, which is tactilely perceptible and can be pressed against the touch surface by the user. A control is devised to display to the user for one or several of the at least one function key by means of the display through the respective see-through region a function of the function key in question. The function varies depending on the operating mode in which a device to be operated by means of the operating console is operated or is to be operated, or depending on the menu type with which the operating console is operated.

### BACKGROUND

The present invention relates to an operating console having a touchscreen for operating a device, in particular for operating a device connected to a vehicle.

For operating devices, in particular on vehicles, for example construction vehicles or water cannon vehicles, operating apparatuses are usually employed, by means of which device functions of the respective device can be controlled. Such operating apparatuses, which are also known as operating consoles, have several buttons, by actuation of which an operator can control the device functions assigned to the buttons.

For the operation of complex machines, it is possible to configure the buttons in the form of numerous keys with their own printing and thus defined function. The disadvantage of such keys with a defined function consists in the fact that a very large number of keys is required to cover all the necessary functions, in particular if a very wide variety of operating modes, which require operating functions different from one another, are to be covered by means of the operating console. If an operating mode is employed only rarely, the keys in question, which are relevant only for this operating mode, are largely useless. Such operating modes can relate to, for example, a set-up mode, a transport journey and/or a working mode of the device or of the vehicle in question.

In order to reduce the number of keys and thus the size of the operating panel of the operating console, it is known to employ touch displays on which changing functions can be defined by variable icons. However, the disadvantage of such touch displays is that they are not suitable for robust working environments. A soiling of capacitive displays can lead to undesired effects. Even resistive touch displays are not always easy to use, especially not with work gloves. Even when working in the dark, touch displays are not ideal despite the possibility of an illuminated night design.

### SUMMARY

The object of the present invention is therefore to create an operating console which avoids the abovementioned disadvantages of known operating consoles.

The object is achieved according to the invention by an operating console with the features of the appended independent claim 1. Developments and advantageous embodiments are stated in claims dependent thereon.

According to one aspect of the present disclosure, an operating console is proposed which has a display which is configured as a resistive touch display and accordingly has a touch surface. Above the touch surface a film is arranged which covers the touch surface, preferably completely, and which has at least one function key, preferably a plurality of function keys. The function keys have, on the one hand, a transparent or at least translucent see-through region in an environment which in comparison thereto is more opaque, and through which the display is visually perceptible. The transparency should be as high as possible, wherein, because 100% transparency is virtually impossible, a translucency of 90% or more is regarded as transparent for the purposes of the present invention. In addition, the function key has an arching region which extends in a direction away from the touch surface. This arching region is tactilely perceptible and preferably extends at least one millimeter over an outer surface of the film. The arching region serves to enable the user not only to find the function key blindly and to detect it tactilely, but also to press it against the touch surface of the resistive touch display and thus actuate the function key. Finally, a control is also provided which is devised to display to the user for one or several function keys by means of the display through the respective see-through region a function of the function key in question, which varies depending on an individual specification.

An operating console designed in this way is particularly suitable for operating a device which can be operated in different operating modes. In this case, the individual specification, which the function displayed in the see-through region of the function key in question depends on, is the specific operating mode in which the device to be operated by means of the operating console is operated or is to be operated. Preferably, the operating console is configured such that the user himself can select between a plurality of operating modes by means of the operating console.

An operating console designed in this way can, however, is employable advantageously in the same way if the operating console does not (or not solely) serve for operating a device in different operating modes but is (also) operated with different menu types. In this case, the individual specification, which the function displayed in the see-through region of the function key in question depends on, is the specific menu type which the operating console is operated with. Such menu types can be, for example, a settings menu, services menu, operating menu and/or other menu.

The operating console combines compactness and easy operability with low manufacturing costs. The compactness is attained by the fact that function keys are assigned a different function depending on the selected operating mode, so that they are basically multi-function keys. Hereby the number of function keys can be kept small. The simple operability of the operating console results from, on the one hand, the fact that the arching regions of the function keys are tactilely perceptible so that they can be found even in poor lighting conditions or, where applicable, without looking. On the other hand, the environment which in comparison to the see-through region is more opaque facilitates the finding of the see-through region and thus the finding of the function key in question. In this connection, it is particularly advantageous if the tactilely perceptible arching region, which is pressed against the touch surface of the touch display by the user, is configured in the see-through region of the function key so that precisely the area to be actuated by the user can be easily found.

The operating console can be manufactured inexpensively because a conventional resistive touch display can be employed, over whose touch surface the film having the function keys is attached. For example, the film can be glued to the touch display in a simple manner. Furthermore, the operating console is robust in several respects, on the one hand, because a conventional, robust resistive touch display can be used and, on the other hand, because the film of this touch display additionally protects against soiling and other environmental factors. In contrast to a capacitive touch display, which triggers already upon approach, the resistive touch display offers the advantage that it triggers only when the touch surface is actively (slightly) pressed in.

In this connection it is advantageous if a hollow space is present under the arching region. Indeed, the arching region can also be formed by an outwardly thickening partial region of the film. However, a hollow space in the arching region offers the advantage that the user receives a better feedback feeling because he has to press the button deeper and with a necessary minimum pressure and thus experiences a more intensive pressing experience.

The arch with subjacent cavity can be achieved in a simple and inexpensive manner by embossing, in particular by hot embossing. The film itself can have a thickness between 100 μm and 400 μm, preferably about 200 μm. This applies in particular to the arching region if a hollow space is present under the arching region, wherein the specific thickness is selected depending on the material of the film such that the pressing down of the arching region does not require too much force but also does not take place unintentionally. The film is preferably a plastic film, wherein polyester had proved particularly suitable for the film material. Alternatively, the film can also be a silicone film and hereby form a grippy silicon structure or keyboard. In particular, the silicone film can be configured as relatively thick and have a mat-like shape. Alternatively, the silicone film or silicone mat can also be provided additionally over the actual plastic film.

In addition to the multi-function keys, the operating console can advantageously have one or several further function keys which are constructed in correspondence with the multi-function keys but are independent of the operating mode. That is to say, for these function keys the respective function, which is independent of the operating mode, is always displayed in the same way by means of the display through the see-through region of the function key, independent of the selected operating mode. Keys with a fixed function can also be printed with a fixed symbol in the film.

Preferably, the environment which is more opaque in comparison to the see-through region is completely opaque, that is to say non-transparent. This can be realized in a simple and correspondingly inexpensive manner by an opaque, preferably black or grey coating on the upper side of the film or, particularly preferably, on the underside of the film. Coating the underside of the film has the advantage that the opaque imprint cannot wear out by the normal operation. The coating of the upper side of the film has the advantage that, in particular when using a matt coating, the unprinted see-through regions are particularly easily identifiable. Alternatively, the upper side of the film can be matted outside the see-through regions.

In the opaque environment of the function key, a transparent or at least translucent status window can additionally be provided, for example in the form of a small circular or polygonal see-through region, wherein the control in this respect is devised to display, by means of the display in the status window, a color code which varies depending on the status. The see-through region is preferably produced in such a way that the opaque coating on the film is absent in the region of the status window, or in which the status window is cut out of the film. The color code displayed in the status window by means of the display can preferably be generated with 8 bits per color channel, i.e. can vary by up to 16.8 million colors. In particular, the color code can vary between three colors, for example green, red and yellow, or also only between two colors or also between two or several of these and/or other colors, if the display under the status window lights up in the corresponding color.

Thus, green can stand for a switched-on, inactive state, yellow for a switched-on, active state, red for a critical state, and no illumination for a switched-off state. Other encodings are, of course, possible. Alternatively, the state of the function key can also be generated by coloring the icon or the background color of the icon.

Preferably, the opaque environment not only surrounds the see-through region of a function key and, if present, of an associated status window, but also surrounds a plurality of see-through regions (and status windows). That is, several function keys are arranged in an opaque area.

In addition to the see-through regions of the function keys and, where applicable, of the associated status windows, one or several transparent or at least translucent display windows can be provided in the opaque environment, wherein the control, with respect to the display window, is devised to display any information items in the display window by means of the display. The display does not need to be touch-sensitive in the region of the display window, although this is not excluded.

The resistive touch display can comprise a conventional TFT display as the display device. However, other display devices can also be employed, for example a glass-to-glass touch display.

Arranged above the display device of the touch display is the resistive touch sensor which, for example in the conventional manner, can have two PET films with an ITO coating arranged one above the other. The two PET films are slight spaced apart and are pressed against one another by actuating the function keys so that the respective ITO coatings come into contact with one another and trigger a corresponding signal. The see-through regions of the function keys are in turn preferably free of electrically conductive structures. The pressure sensitivity of resistive touch displays can be adjusted via the distance between the contact points to be brought into contact with one another.

The operating modes of the device to be controlled by means of the operating console can be very different. For example, in a vehicle-mounted device, such as on construction vehicles or water cannon vehicles, the operating modes can be directed to a set-up mode, a transport journey, a working mode, etc.

According to a preferred embodiment, the function of one or several of the function keys comprises a safety function. For example, the safety function key can be activated only by simultaneously or sequentially actuating a second key. In particular, the second key can be another function key on the film of the touch display or a standard key. The second key is also preferably tactilely perceptible for the user.

### BRIEF DESCRIPTION OF THE DRAWINGS

Preferred embodiments of the invention and further advantageous embodiments are explained in more detail with reference to the accompanying drawings. There are shown:

FIG. 1 a schematic representation of an operating console in top view;

FIG. 2 a cross-section of the operating console of FIG. 1 along the line II-II;

FIG. 3 the operating console of FIG. 1 in a first operating mode; and FIG. 4 the operating console of FIG. 1 in a second operating mode.

### DETAILED DESCRIPTION OF THE INVENTION

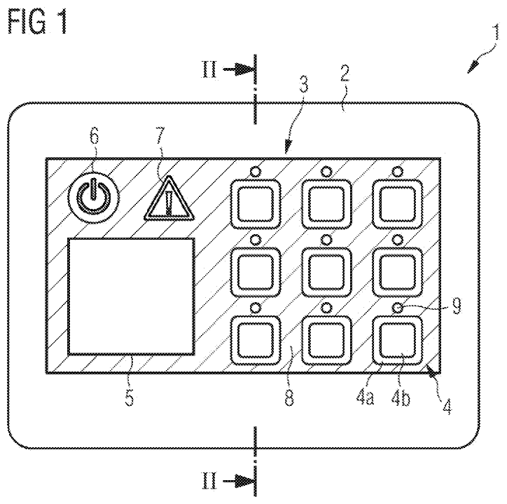

FIG. 1 shows an operating console 1 according to a preferred embodiment example schematically in plan view. The operating console 1 comprises a frame 2 in which a display 3 is accommodated. The display 3 with a plurality of function keys 4, a display window 5 for displaying arbitrary information items and further, static display fields 6 and 7, which here have the shape of an on/off switch and a warning icon. In the region of the function keys 4 and the display window 5, information items for the user can be displayed by means of the display, whereas the environment 8 of these regions 4, 5 as well as of the display fields 6 and 7 is printed opaquely, preferably black or grey. The printing ink is preferably matt so that the display window 5 and in particular the function keys 4 optically stand out from the environment 8. In this preferred embodiment example, each function key 4 (alternatively only one or individual ones) is associated with a status window 9 which is likewise transparent or at least translucent. Here, the status windows 9 are circular, but can assume any desired shape. They serve to indicate the current status of that function which is displayed by means of the display 3 in the region of the associated function key 4, for example by a green or red or, where applicable, also yellow light, wherein it also is possible to use other colors, such as, for example, blue. Green can, for example, mean that the function displayed in the region of the function key 4 in question is switched on, but is inactive, while red means that the function is critical, whereas yellow can mean that the function is switched on and is also active.

The function keys 4 thus respectively comprise a transparent see-through region which is designated by 4a in FIG. 1. Within the see-through region 4a, the display has an upwardly, i.e. outwardly, directed arch 4b in each of the function keys 4 which is tactilely perceptible and can be pressed downward or rearward by the user in order to generate a signal via the display which is related to the function in question of the function key 4, for example switches the function in question off or on.

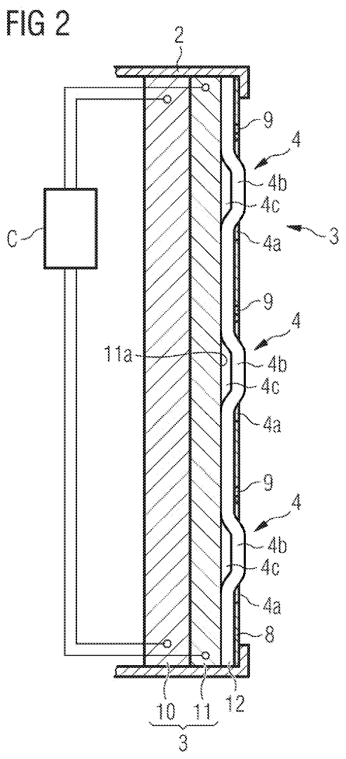

Correspondingly, the display 3 is a touch display, specifically a resistive touch display, as will be explained below with reference to the schematic cross-section through the display 3 according to FIG. 2. The display 3 consists of two layers 10 and 11 accommodated in the frame 2. The lowermost layer 10 is the display device of the resistive touch display 3, which is, for example, a TFT display. The person skilled in the art is familiar with further display devices which can alternatively be employed instead of the TFT display. Above this, a touch sensor is located as layer 11. Essentially, capacitive and resistive touch sensors for touch displays are known, wherein the touch sensor layer 11 a resistive touch sensor. The construction of resistive touch sensors is generally known and essentially comprises two layers, for example PET films, which are slightly spaced apart from one another and each have internal conducting-path structures which, when they come into contact with one another by the action of external pressure, produce a corresponding signal. The conducting-path structures are so fine that they do not interfere with the view onto the subjacent display device. They can be configured, for example, in an ITO coating. The TFT display layer 10 and the touch sensor layer 11 are respectively connected to a control C which, on the one hand, registers the signals from the touch layer 11 and, on the other hand, produces the information item to be displayed by means of the TFT display layer 10. Above the contact layer 11 lies, as the further layer 12, a transparent film in which the previously described function keys 4 are configured. The film is preferably a polyester film. The function keys 4 respectively comprise, on the one hand, a see-through region 4a and an arching region 4b. The opaque environment 8, which delimits the see-through regions 4a, is formed by an opaque imprint on the outside of the transparent film 12. Alternatively, this imprint can also be present on the inner surface of the transparent film 12. Instead of printing on the opaque environment 8, another coating method can also be chosen. In the region of the status window 9 respectively assigned to the function keys 4, the opaque environment 8 is likewise left out so that the TFT display layer 10 is perceptible through the status window 9, the transparent film 12 and the touch sensor layer 11.

The arching regions 4b of the transparent film 12 are preferably embossed and particularly preferably manufactured by the hot-embossing process. Alternatively, a silicone material can also be employed which dispenses with the hollow space. This material can be employed in combination with the polyester film or as a pure silicone mat. In this way, a hollow space 4c is created underneath each arching region 4b. A user correspondingly actuates the function keys 4 by pressing the arching region 4b against a touch surface 11a of the touch sensor layer 11 in order to thus electrically short-circuit the corresponding point in the touch sensor layer 11 and to produce a corresponding signal which is processed by the control C. Due to the inherent elasticity of the film 12, the film moves back into the curved starting position after the switching operation. Preferably, the thickness of the film 12, at least in the arching region 4b, is between 100 μm and 400 μm, e.g. 200 μm.

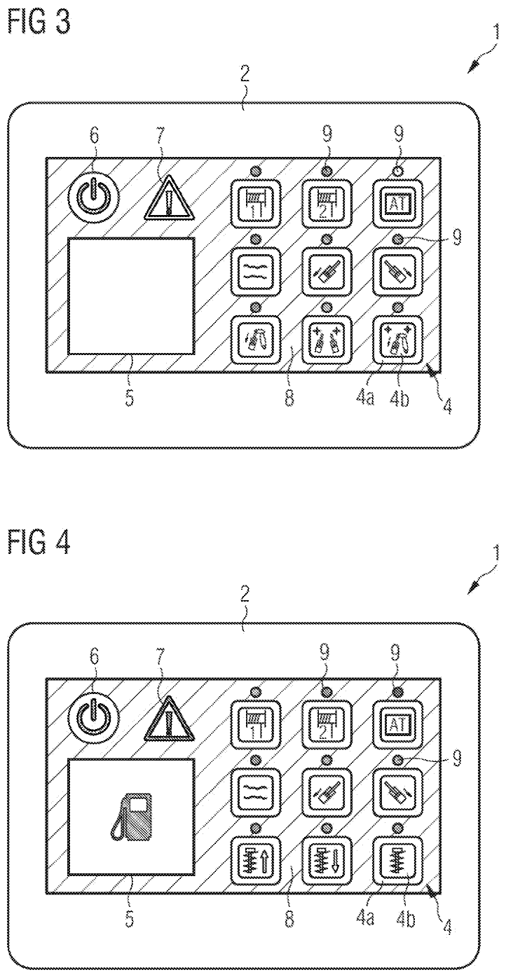

While the operating console is switched off in the state represented in FIG. 1 and accordingly does not display any functions in the see-through regions 4a, FIGS. 3 and 4 show the operating console in the switched-on state for operating a device which is operated in different operating modes. In the process, the two upper function-key rows are independent of the operating mode. That is to say, the function assigned to the function key 4 in question is displayed in the same way by means of the display through the respective see-through region 4a in the two operating modes shown in FIGS. 3 and 4. This is different for the three function keys 4 in the lower function-key row. Here, the function keys 4 are dependent on the respective operating mode of the device to be controlled. In the operating mode according to FIG. 3, therefore, different information items are displayed in the corresponding see-through regions 4a by means of the display lying underneath, namely in the form of icons or symbols, than in the operating mode according to FIG. 4.

The respective 9 status of the function which belongs to the function key 4 in question is displayed in the status windows. A red status display is represented, for example, as black in FIGS. 3 and 4, a green status display as grey and no status display as white. With respect to the status window 9, only the status display of the upper right-hand status window 9 has changed from white (without function in this operating mode) to yellow (active and in operation) between FIGS. 3 and 4.

In addition, in the embodiment example according to FIG. 4, the warning display field 7 lights up clearly red (shown in black), and a fuel pump symbol is shown in the display window 5, which makes it clear to the user that the warning display field is lighting up because of a low fuel level. The display window 5 can display any other information items. It can also be configured as a touch display. The on/off switch in the display field 6 can also be configured as a touch display so that in the switched-on state of the touch display, in which thus the touch function of the display window is energized, touching the on/off switch would effectuate a changing of the device to a standby mode. In this case it is expedient to configure the transparent film 12 with an arching region 4b also in this display field 6. In particular, the touch display, in contrast to what is shown here, can also be devised to allow the user to switch between different operating modes of the device to be controlled with it.

1.-20. (canceled)

21. An operating console for operating a device, comprising:
a display configured as a resistive touch display having a touch surface,
a film covering the touch surface, wherein the film has at least one function key which, on the one hand, comprises a transparent or at least translucent see-through region in an environment which in comparison thereto is more opaque, and through which the display is visually perceptible, and which, on the other hand, comprises an arching region, which extends in a direction away from the touch surface, which is tactilely perceptible and can be pressed against the touch surface by the user, and
a control which is devised to display to the user for one or several of the at least one function key by means of the display through the respective see-through region a function of the function key in question, which varies depending on an individual specification.

22. The operating console according to claim 21, wherein the device to be operated by means of the operating console can be operated in different operating modes, and wherein the individual specification, which the function displayed in the see-through region of the function key in question depends on, is the specific operating mode in which the device to be operated by means of the operating console is operated or is to be operated.

23. The operating console according to claim 22, wherein the operating modes comprise one or several of the following operating modes of a device, in particular on a vehicle, for example a construction vehicle or a water cannon vehicle: set-up mode, transport journey, working mode.

24. The operating console according to claim 21, wherein the operating console can be operated with different menu types, and wherein the individual specification which the function displayed in the see-through region of the function key in question depends on is the specific menu type which the operating console is operated with.

25. The operating console according to claim 21, wherein the arching region is configured in the see-through region.

26. The operating console according to claim 21, wherein a hollow space is present under the arching region.

27. The operating console according to claim 26, wherein the arching region is an embossed, in particular hot-embossed, region of the film.

28. The operating console according to claim 26, wherein the film has a thickness in the range of 100 μm to 400 μm, preferably about 200 μm, at least in the arching region.

29. The operating console according to claim 21, wherein the film is a polyester film or silicone film, preferably a mat-like silicone film.

30. The operating console according to claim 21, wherein the function of one or several of the at least one function key is independent of the individual specification, and wherein the respective function of the function key in question is always displayed in the same way by means of the display through the see-through region independently of the individual specification.

31. The operating console according to claim 21, wherein a transparent or at least translucent status window is provided in the opaque environment beside the see-through region and wherein the control is devised to display, in the status window by means of the display, a color code which varies depending on the status.

32. The operating console according to claim 31, wherein the color code can vary between two or three colors.

33. The operating console according to claim 21, wherein the opaque environment is formed by an opaque coating on the upper side or preferably on the underside of the film.

34. The operating console according to claim 21, wherein the opaque environment surrounds see-through regions of a plurality of the at least one function key and, if present, associated status windows.

35. The operating console according to claim 21, wherein the opaque environment, in addition to the see-through region of the at least one function key, surrounds a transparent or at least translucent display window, and wherein the control is devised to display any information items in the display window by means of the display.

36. The operating console according to claim 21, wherein the display comprises a TFT display as the display device.

37. The operating console according to claim 21, wherein the display has as a touch sensor two PET films having ITO coating arranged on top of each other or is configured as a resistive glass-to-glass touch display.

38. The operating console according to claim 21, wherein the film is free of electrically conductive structures in the see-through region of the function key.

39. The operating console according to claim 21, wherein the function of the function key comprises a safety function in which the function key can be activated only upon simultaneous or sequential actuation of a second key.

40. The operating console according to claim 39, wherein the second key is another function key of the film or a standard key.
